(19) United States
(12) Patent Application Publication
(10) Pub. No.: US 2025/0206849 A1
(43) Pub. Date: Jun. 26, 2025

(54) PROCESS FOR MANUFACTURING OF NANOCRYSTALLINE CELLULOSE (NCC)

(71) Applicant: SixRing Inc., Calgary (CA)

(72) Inventors: Alejandra ENRIQUEZ, Calgary (CA); Markus WEISSENBERGER, Calgary (CA); Elsayed ADBELFATAH, Calgary (CA)

(21) Appl. No.: 18/750,825

(22) Filed: Jun. 21, 2024

(30) Foreign Application Priority Data
Dec. 21, 2023 (CA) 3224384

(51) Int. Cl. C08B 15/08

(52) U.S. Cl. CPC C08B 15/08

(57) ABSTRACT

A process to manufacture nanocrystalline cellulose from a cellulose having a low hemicellulose content, said process comprising the steps of:
exposing said cellulose to a solution comprising a microemulsion for a first pre-determined period of time, thereby creating a cellulose suspension comprising said microemulsion and a swollen cellulose;
optionally, separating said microemulsion from said swollen cellulose;
exposing said swollen cellulose to a source of peroxide (such as H₂O₂) and a metal salt selected from the group consisting of: FeSO₄; CuSO₄; and combinations thereof, under acidic conditions, for a second pre-determined period causing hydrolysis of the cellulose; and
recovering a resulting nanocrystalline cellulose, wherein the cellulose has a particle size ranging from 100 to 1000 μm.

### FIELD OF THE INVENTION

The present invention is directed to a process to manufacture nanocrystalline cellulose, more specifically the process converts highly delignified cellulose fibers into nanocrystalline cellulose by applying a pre-treatment to the former.

### BACKGROUND OF THE INVENTION

Nanocrystalline cellulose (NCC) or cellulose nanocrystals (CNCs) has many attractive characteristics, such as a high specific surface area, high thermal stability, a large number of functional groups, biocompatibility, high crystallinity, and macroscopic material advantages, which come with the colloidal size range of 1 to 500 nm. Due to these, it has a number of different applications in wastewater treatment systems, emulsification and Pickering emulsions, food, cosmetics, structured materials, polymer nanocomposites, cementitious composites, etc.

Using sonication for making NCC from microcrystalline cellulose (MCC) has been reported in the literature. However, very powerful sonicators (500 W) were used for extended period of time (at least 50 minutes). This process is hard to scale up due to the technical issues associated with operating ultrasonic processors for long periods of time that includes enormous amounts of heat generation.

Radical-based catalytic decomposition of cellulose to NCC is discussed in Facile and Green Synthesis of Carboxylated Cellulose Nanocrystals as Efficient Adsorbents in Wastewater Treatments. ACS Sustainable Chem. Eng. 2019, 7, 21, 18067-18075.

Chinese patent CN108779183B teaches a method for producing nanocellulose, said method comprising the steps of: a) providing a cellulose-containing material, wherein the cellulose-containing material comprises less than 20 wt % water; b) contacting the cellulose-containing material with oxalic acid dihydrate and heating above the melting point of oxalic acid dihydrate to obtain cellulose oxalate; c) washing the mixture; d) preparing a suspension containing the washed material from step c); and e) recovering the nanocellulose from the suspension. The present invention also relates to a process for the manufacture of a nanocellulose intermediate, said process comprising the above steps a) to c).

Chinese patent CN102432686B teaches a micro-nano cellulose that is obtained by reacting microcrystalline cellulose and a metal salt with a high-boiling point alcohol solution. Its preparation method comprises the steps: (1) combining microcrystalline cellulose with the metal salt high-boiling point alcohol solution, to form a liquid suspension; (2) reacting the liquid suspension for 1-8 h under 100° C.˜240° C., to obtain a microcrystalline cellulose/metal-salt mixed solution; (3) combining distilled water with the microcrystalline cellulose/metal-salt mixed solution and centrifuging the mixture.

Swedish patent SE539317C2 teaches a method for manufacturing nanocrystalline cellulose, said method comprising the steps of: a. providing a cellulose-containing material wherein the cellulose-containing material contains less than 20 wt % water, preferably less than 10 wt. % water, b. contacting the cellulose-containing material with oxalic acid dihydrate, and heating above the melting point of the oxalic acid dihydrate, to obtain cellulose oxalates, c. washing the mixture resulting from step b), d. preparing a suspension comprising the washed material from step c), and e. recovering nanocrystalline cellulose from the suspension.

Malaysian patent document MY189437 discloses a method of producing nanocellulose from sugarcane bagasse (SCB) comprising the step of subjecting the SCB to sodium hydroxide treatment for partial separation of lignin and hemicellulose therefrom; bleaching the pre-treated SCB with hydrogen peroxide solution for further removal of lignin and hemicellulose to obtain cellulose; ultrasonicating the cellulose to obtain nanocellulose; and hydrolyzing the nanocellulose with 0.1 to 1% (v/v) of sulphuric acid solution to obtain nanocellulose with an aspect ratio of 100-150.

Chinese patent application CN1470552A discloses a nano-grade cellulosic particulate preparation method that comprises the steps: (1) the microcrystalline cellulose aggregate and antioxidant are dissolved in the cellosolve and stirred to obtain a cellulose suspension; (2) the cellulose suspension is added into the precipitating solvent that contains a dispersion agent, by stirring and emulsifying a nano-cellulose particulate emulsion is formed.

U.S. Pat. No. 10,144,786B2 teaches a method of making nanocrystalline cellulose, consisting of the sequential steps of: grinding cellulosic fibers to produce ground cellulose fiber; drying the ground cellulose fiber to produce dried, ground cellulose, wherein the drying is done at about 105° C. for two hours; freeze-drying the dried, ground cellulose by exposing the dried, ground cellulose to liquid nitrogen-vapor for five minutes to produce lyophilized cellulose; adding at least 98.06% pure sulfuric acid to the lyophilized cellulose at a liquid/solid ratio of 1:1 (vol/wt) and stirring to form a cellulosic paste; diluting the cellulose paste in a cold liquid at a liquid/solid ratio of 1:1 (vol/wt) to form a cellulosic solution, wherein the cold liquid is selected from the group consisting of water and absolute ethanol; filtering the cellulosic solution under cooling by liquid nitrogen-vapor to produce a nanocrystalline cellulose precipitate; washing the nanocrystalline cellulose precipitate until neutralization, wherein the washing is performed in a liquid selected from the group consisting of cold water and ethanol; and air-drying the washed nanocrystalline cellulose precipitate for one hour to yield a nanocrystalline cellulose product, wherein the cellulose product comprises cellulose needles configured as whiskers.

EP patent application 3608432 A1 discloses a method for producing cellulose nanocrystals (CNCs) comprising: i) a step of feeding a cellulosic raw material, such as native vegetable fibres or vegetable biomass materials or by-products of the textile, milling industries, and of paper, ii) a step of putting the cellulosic raw material in contact with an oxidative acid component at high temperature to produce cellulose nanocrystals (CNCs) and iii) a step of recovery of the cellulose nanocrystals obtained, in which method there is provided a hydrolytic-oxidative microwave-assisted treatment, with closed microwave reactor under pressurised conditions. The nanocrystals obtained can advantageously form pourable suspensions, for example as a thin and functional cladding on the activated surface of flexible packaging materials.

US patent application 2019/0023857 discloses a method for preparing a non-acid-treated eco-friendly cellulose nanocrystal and the cellulose nanocrystals prepared by the same. The methods for preparing the non-acid-treated cellulose nanocrystal and extracting the cellulose nanocrystal from cellulosic materials of the present invention are eco-friendly methods, compared with the conventional preparation method for cellulose nanocrystal based on acid-hydrolysis; are efficient due to the total energy saving process; are easy to utilize side products; and are characterized by high yield to produce the target cellulose nanocrystal. The nanocrystal prepared according to the present invention exhibits equivalent or higher aspect ratio, yield and crystallinity than the cellulose nanocrystal prepared through acid hydrolysis, and has remarkably excellent thermal stability, so that it can be effectively used for the production of membranes, electrical and electronic parts, substrates, heat insulating materials, and reinforcing materials required for durability against heat.

Canadian patent application CA 3,222,533 discloses a method of producing cellulose nanocrystals from a purified cellulose includes a single stage and/or one-pot reaction of pretreating the cellulose with NaOH before oxidizing the cellulose with a hypohalite solution and a transition metal catalyst.

In light of the prior art, there is a clear need for a method which will allow the conversion of cellulose fibers to nanocrystalline cellulose. It has been determined that a cellulosic feedstock which has a low lignin and low hemicellulose content is more readily converted to a nanocellulose by using a process which comprises exposure to a microemulsion. To the best of the inventors knowledge, no current processes to manufacture NCC involve the use of microemulsions.

### SUMMARY OF THE INVENTION

According to an aspect of the present invention, there is provided a process to manufacture nanocrystalline cellulose from a cellulose having a low hemicellulose content, said process comprising the steps of:
exposing said cellulose to a solution comprising a microemulsion for a first pre-determined period of time, thereby creating a cellulose suspension comprising said microemulsion and a swollen cellulose;
optionally, separating said microemulsion from said swollen cellulose;
exposing said swollen cellulose to a source of peroxide (such as H₂O₂) and a metal salt selected from the group consisting of: FeSO₄ and CuSO₄ and combinations thereof, under acidic conditions for a second pre-determined period causing a hydrolysis of the swollen cellulose; and
recovering a resulting nanocrystalline cellulose, wherein the cellulose has a particle size ranging from 100 to 1000 μm.

Preferably, said resulting nanocrystalline cellulose has a crystallinity index of more than 50%, be needle-like and an aspect ratio ranging from 10:1 length to width to 50:1 length to width.

Preferably, said first pre-determined period of time is at least 5 minutes. More preferably, said first pre-determined period of time ranges from 5 minutes to 24 hours. Even more preferably, said first pre-determined period of time ranges from 5 minutes to 1 hour. Yet more preferably, said first pre-determined period of time ranges from 15 minutes to 1 hour. According to a preferred embodiment of the present invention, said first pre-determined period of time ranges from 30 minutes to 1 hour.

Preferably, the step of exposing the resulting mixture to a source of peroxide and a metal salt occurs at a pH below 7.

According to a preferred embodiment of the present invention, said microemulsion composition comprises:
water;
a solvent;
a nonionic surfactant; and
a hydrophobic component.

Preferably, the solvent is selected from the group consisting of: ethanol; methanol; isopropanol; propanol and other short chain alcohols (a linear or branched C₁-C₁₀ alcohol). Preferably, the nonionic surfactant is selected from the group consisting of alcohol ethoxylates and/or alkyl polyglucosides. Preferably, the hydrophobic component is selected from the group consisting of mineral oil, silicon oil, paraffin oil, and pale oil or a terpene. According to a preferred embodiment of the present invention, an inorganic and/or organic base is added to the microemulsion; where said base is selected from the group consisting of: sodium hydroxide, potassium hydroxide, ammonium hydroxide and alkanolamines such as monoethanolamine (MEA); diethanolamine (DEA); triethanolamine (TEA) and combinations thereof. Preferably, the hydrophobic component is present in the composition in an amount ranging from 0.01 wt. % to 20% wt. More preferably, the hydrophobic component is present in the composition in an amount ranging from 1 wt. % to 15% wt. Preferably, the solvent is present in the composition in an amount ranging from 0.1 wt. % to 20% wt.

Preferably, the microemulsion composition is added to the water in a concentration ranging from 0.1 to 90% wt. More preferably, the microemulsion composition is added to the water in a concentration ranging from 0.2 to 10% wt. even more preferably, the microemulsion composition is added to the water in a concentration ranging from 0.5 to 5% wt.

According to an aspect of the present invention, there is provided a process to manufacture nanocrystalline cellulose from cellulose having a low lignin and low hemicellulose content wherein the lignin content is less than 1% wt. and the hemicellulose content is less than 15% wt. said process comprising the steps of:
exposing said cellulose to a solution comprising a microemulsion for a first pre-determined period of time, thereby creating a cellulose suspension comprising said microemulsion and a swollen cellulose;
optionally, separating said microemulsion from said swollen cellulose;
exposing said swollen cellulose to a source of peroxide (such as H₂O₂) and a metal salt selected from the group consisting of: FeSO₄; CuSO₄; and combinations thereof, under acidic conditions, for a second pre-determined period causing hydrolysis of the cellulose; and
recovering a resulting nanocrystalline cellulose.

According to another aspect of the present invention, there is provided a sonication-free method for the preparation of nanocrystalline cellulose from a lignocellulosic biomass feedstock, where said method comprises the following steps:
providing said lignocellulosic biomass feedstock comprising: cellulose; hemicellulose; and lignin;
exposing the biomass to a modified Caro's acid composition having a pH of less than 1, said modified Caro's acid composition selected from the group consisting of: composition A; composition B; composition C; composition D; composition E; composition F; composition G; composition H; composition I; and composition J; wherein said composition A comprises:
   sulfuric acid;
   a compound comprising an amine moiety and a sulfonic acid moiety; and
   a peroxide; and wherein sulfuric acid, said compound comprising an amine moiety and a sulfonic acid moiety and said peroxide are present in a molar ratio of no less than 1:1:1;
   wherein said composition B comprises:
   sulfuric acid;
   a compound comprising an amine moiety;
   a compound comprising a sulfonic acid moiety; and
   a peroxide; wherein sulfuric acid and said a compound comprising an amine moiety and said compound comprising a sulfonic acid moiety are present in a molar ratio of no less than 1:1:1;
   wherein said composition C comprises:
   an alkylsulfonic acid; and
   a peroxide; wherein said alkylsulfonic acid and said peroxide are present in a molar ratio of no less than 1:1;
   wherein said composition D comprises:
   sulfuric acid;
   a heterocyclic compound; and
   a peroxide; and wherein sulfuric acid and said a heterocyclic compound; are present in a molar ratio of no less than 1:1;
   wherein said composition E comprises:
   sulfuric acid;
   a modifying agent comprising a compound containing an amine group; and
   a peroxide; and wherein sulfuric acid and said compound containing an amine group; are present in a molar ratio of no less than 1:1;
   wherein said composition F comprises:
   sulfuric acid;
   a modifying agent comprising an alkanesulfonic acid and
   a peroxide; and wherein sulfuric acid and said alkanesulfonic acid are present in a molar ratio of no less than 1:1;
   wherein said composition G comprises:
   sulfuric acid;
   a substituted aromatic compound; and
   a peroxide; and wherein sulfuric acid and said substituted aromatic compound; are present in a molar ratio of no less than 1:1;
   wherein said composition H comprises:
   sulfuric acid;
   a modifying agent comprising an arylsulfonic acid;
   a peroxide; and
   optionally, a compound containing an amine group; wherein sulfuric acid and said a arylsulfonic acid; are present in a molar ratio of no less than 1:1;
   wherein said composition I comprises:
   sulfuric acid;
   a heterocyclic compound;
   an alkanesulfonic acid and
   a peroxide; and wherein sulfuric acid and said a heterocyclic compound; are present in a molar ratio of no less than 1:1;
   wherein said composition J comprises:
   sulfuric acid;
   a carbonyl-containing nitrogenous base compound; and
   a peroxide; and wherein sulfuric acid and said a carbonyl-containing nitrogenous base compound; are present in a molar ratio of no less than 1:1;
to create a biomass/acid mixture and allowing exposure to said modified Caro's acid for a period of time sufficient to dissolve enough of the lignin present in said biomass mixture to obtain a kappa number for a remaining solid portion of less than 5 and more preferably, less than 2;
separating the liquid from the remaining solid portion of delignification mixture;
optionally, exposing said remaining solid portion to a caustic composition to dissolve the hemicellulose present therein;
extracting a remaining cellulose;
optionally, adjusting the pH of said remaining cellulose;
exposing said cellulose to a solution comprising a microemulsion for a first pre-determined period of time, thereby creating a cellulose suspension comprising said microemulsion and a swollen cellulose;
optionally, separating said microemulsion from said swollen cellulose;
exposing said swollen cellulose to a source of peroxide (such as H₂O₂) and a metal salt selected from the group consisting of: FeSO₄; CuSO₄; and combinations thereof, under acidic conditions, for a second pre-determined period causing hydrolysis of the cellulose; and
recovering a resulting nanocrystalline cellulose.

According to yet another aspect of the present invention, there is provided a sonication-free method for increasing the yield of nanocrystalline cellulose from a cellulose having a low hemicellulose content (less than 15% wt.), said process comprising the steps of:
exposing said cellulose to a solution comprising a microemulsion for a first pre-determined period of time, thereby creating a cellulose suspension comprising said microemulsion and a swollen cellulose;
optionally, separating said microemulsion from said swollen cellulose;
exposing said swollen cellulose to a source of peroxide (such as H₂O₂) and a metal salt selected from the group consisting of: FeSO₄ or CuSO₄ under acidic conditions, for a second pre-determined period causing hydrolysis of the cellulose; and
recovering the resulting nanocrystalline cellulose,
   wherein the cellulose has a particle size ranging from 100 to 1000 μm.

Preferably, said cellulose is obtained from a lignocellulosic biomass feedstock, where said method comprises the following steps:
providing said lignocellulosic biomass feedstock comprising: cellulose; hemicellulose; and lignin;
exposing the biomass to a modified Caro's acid composition having a pH of less than 1, said modified Caro's acid composition selected from the group consisting of: composition A; composition B; composition C; composition D; composition E; composition F; composition G; composition H; composition I; and composition J;
   wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
   wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
   wherein said composition C comprises:
an alkylsulfonic acid; and
a peroxide; wherein said alkylsulfonic acid and said peroxide are present in a molar ratio of no less than 1:1;
   wherein said composition D comprises:
sulfuric acid;
a heterocyclic compound; and
a peroxide; and wherein sulfuric acid and said a heterocyclic compound; are present in a molar ratio of no less than 1:1;
   wherein said composition E comprises:
sulfuric acid;
a modifying agent comprising a compound containing an amine group; and
a peroxide; and wherein sulfuric acid and said compound containing an amine group; are present in a molar ratio of no less than 1:1;
   wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
   wherein said composition G comprises:
sulfuric acid;
a substituted aromatic compound; and
a peroxide; and wherein sulfuric acid and said substituted aromatic compound; are present in a molar ratio of no less than 1:1;
   wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
   wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
   wherein said composition J comprises:
sulfuric acid;
a carbonyl-containing nitrogenous base compound; and
a peroxide; and wherein sulfuric acid and said a carbonyl-containing nitrogenous base compound are present in a molar ratio of no less than 1:1;
to create a biomass/acid mixture and to allow exposure to said modified Caro's acid for a period of time sufficient to dissolve enough of the lignin present in said biomass mixture to obtain a kappa number for a remaining solid portion of less than 5 and more preferably, less than 2;
separating the liquid from the remaining solid portion of delignification mixture;
optionally, exposing the remaining solid portion to a caustic composition to dissolve the hemicellulose present therein;
extracting a remaining cellulose; and
optionally, adjusting the pH of said remaining cellulose.

According to a preferred embodiment of the present invention, the process (which does not employ sonication) can provide NCC in a yield of 20 to 50% higher than a similar process (which is also sonication-free) which does not use a microemulsion.

### BRIEF DESCRIPTION OF THE FIGURES

Features and advantages of embodiments of the present application will become apparent from the following detailed description and the appended figures, in which:

FIG. 1 is the particle size distribution graphs of NDCSW (softwood);

FIG. 2 is the graph showing the NCC particle size distribution for NCS-22

FIG. 3 is the graph showing the NCC particle size distribution for Control-1, ME1 and ME3 from Experiment #3

FIG. 2 is the graph showing the NCC particle size distribution for Control-2, ME2 and ME4 from Experiment #3

### DETAILED DESCRIPTION OF THE INVENTION

According to a preferred embodiment of the present invention, there is provided a process for producing nanocrystalline cellulose (NCC) from a feedstock of cellulose the latter which is also referred to as “never dried cellulose” (NDC). NDC is simply a reference to a cellulose which is obtained from a delignification reaction using a modified Caro's acid according to a composition described herein and which has not undergone significant drying subsequent to the delignification step.

According to a preferred embodiment of the present invention, there is provided a process for producing nanocrystalline cellulose (NCC) from a feedstock of cellulose, wherein the particle size of said cellulose ranges between 100 to 1000 μm.

It is known in the industry that cellulose, which is obtained after delignifying biomass, can undergo hornification upon being exposed to drying conditions. Hornification has a significant impact on both the surface chemistry of cellulosic fibers but also on the internal space found within a cellulosic fiber. In certain instances, it is desirably to avoid hornification of the cellulose as it will render future processing of the same much more difficult, depending on the type of processing. Drying of fibers causes the loss of large pores inside the network of cellulose due to increased H-bonding and a reduction of the surface area, which does impact the surface chemistry.

It is thought that conventionally obtained cellulose (for example, from the kraft process), contains a significant amount of lignin which requires bleaching for further use. The kraft process is not directed to the removal of hemicellulose whose presence is desirable for paper production as it acts as a binder of the cellulose but which, depending on the chemical reaction the cellulose is exposed, may consume the reagent and prevent an optimal yield. In the present case, the cellulose is to be chemically converted to nanocrystalline cellulose through a radical-based hydrolysis, where the amorphous sections present on cellulosic fibers are more susceptible to the attack of the chemical treatment. Hemicelluloses also exhibit amorphous characteristics, which render them also more susceptible to hydrolysis. Using a pulp which has a significant hemicellulose content would necessarily lead to waste of reagent, which would act upon the hemicellulose rather than on the amorphous sections of cellulose, thereby causing a significant decrease in the yield of NCC, large chemical consumptions, and prolonged reaction times.

According to a preferred embodiment of the present invention, the cellulose used as starting material is low in both lignin and hemicellulose and therefore less prone to chemical reagent waste.

According to a preferred embodiment of the present invention, the cellulose used as starting material is a pulp having a hemicellulose content of less than 15% w/w. Preferably, the hemicellulose content of the cellulose used as starting material is less than 10% w/w. More preferably, the hemicellulose content is less than 5% w/w of the cellulose used as starting material.

According to a preferred embodiment of the present invention, the cellulose used as starting material is a pulp having a Kappa number of less than 5. Preferably, the Kappa number of the cellulose used as starting material is less than 2. More preferably, the Kappa number of the cellulose used as starting material is less than 1.

According to a preferred embodiment of the present invention, the process comprises a step of swelling cellulose in a water (or basic solution) that comprises a microemulsion. Optionally, after the swelling is complete, the swollen fiber can be separated from the microemulsion using common solid-liquid separation techniques. Finally, the fiber suspension or isolated fiber is treated chemically using a mixture of hydrogen peroxide and an iron sulfate catalyst. Preferably the reaction with a mixture of hydrogen peroxide and an iron sulfate catalyst occurs at a temperature of less than 100° C. More preferably, the reaction with a mixture of hydrogen peroxide and an iron sulfate catalyst occurs at a temperature of less than 70° C.

It is important to note that the separation of the microemulsion from the swollen fiber or soaked cellulose is an important step to enhance the cost effectiveness of the manufacturing process as said microemulsion may be recycled through a number of different cycles; thus, significantly lowering the costs associated to the production of large volumes of microemulsion.

It was found that soaking a cellulose having a low hemicellulose content with a microemulsion significantly enhanced the NCC yield obtained from catalytic decomposition of hydrogen peroxide with iron sulfate, copper sulfate or iron oxide.

According to a preferred embodiment of the present invention, the pretreatment of the cellulose with a microemulsion allows the subsequent hydrolysis to more efficiently cleave the amorphous cellulose fragments present on the cellulose. By depolymerization of those amorphous cellulose fragments, the process yields the aforementioned NCC. It has been noted that the presence of hemicellulose along with the cellulose will hamper the conversion of said cellulose to NCC. It is believed that a large portion of the chemicals get consumed by the hemicellulose rather than cleaving the amorphous cellulose portions of the cellulose fibers.

### EXPERIMENTAL

### Example 1

According to a first preferred embodiment of the present invention, a microemulsion composition was prepared using deionized water, MEA, ethanol, DDBSA (dodecyl benzene sulfonic acid), Novel® 23E7, and Pale Oil 40. The constituents of the composition are listed in Table 1 (below) along with their amounts.

TABLE 1
Composition according to a preferred embodiment
of the present invention labelled OSD P215

| Constituent | wt % |
|---|---|
| DI Water | 85.68 |
| MEA | 0.57 |
| Ethanol | 3.75 |
| Novel ® 23E7 | 6.67 |
| DDBSA | 2.83 |
| Pale Oil 40 | 0.50 |
| Total | 100.00 |

### Example 2

According to a second preferred embodiment of the present invention, a microemulsion composition was prepared using deionized water, MEA, ethanol, DDBSA (dodecyl benzene sulfonic acid), Novel® 23E7, and Citral. The constituents of the composition are listed in Table 2 (below) along with their amounts.

TABLE 2
Composition according to a preferred embodiment
of the present invention labelled OSD C217

| Constituent | wt % |
|---|---|
| DI Water | 84.17 |
| Ethanol | 3.75 |
| MEA | 0.58 |
| DDBSA | 2.83 |
| Novel ® 23E7 | 6.67 |
| Citral | 2.00 |
| Total | 100.00 |

### Example 3

According to a third preferred embodiment of the present invention, a microemulsion composition was prepared using deionized water, MEA, ethanol, DDBSA (dodecyl benzene sulfonic acid), Novel® 23E7, and Citral. The constituents of the composition are listed in Table 3 (below) along with their amounts.

TABLE 3
Composition according to a preferred embodiment
of the present invention labelled C225

| Constituent | wt % |
|---|---|
| DI Water | 77.77 |
| MEA | 0.85 |
| Ethanol | 5.63 |
| Novel ® 23E7 | 10.00 |
| DDBSA | 4.25 |
| Citral | 1.50 |
| Total | 100.00 |

### Example 4

According to a fourth preferred embodiment of the present invention, a microemulsion composition was prepared using deionized water, MEA, Triton™ BG-10, DDBSA (dodecyl benzene sulfonic acid), and Pale Oil 40. The constituents of the composition are listed in Table 4 (below) along with their amounts.

TABLE 4
Composition according to a preferred embodiment
of the present invention labelled Nano-X11-3

| Constituent | wt % |
|---|---|
| DI Water | 78.50 |
| MEA | 0.50 |
| Triton BG-10 | 15.00 |
| DDBSA | 5.00 |
| Pale Oil 40 | 1.00 |
| Total | 100.00 |

### Example 5

According to a fifth preferred embodiment of the present invention, a microemulsion composition was prepared using deionized water, ethanol, Lutensol® XL-90, Novel® 23E7, and Pale Oil 40. The constituents of the composition are listed in Table 5 (below) along with their amounts.

TABLE 5
Composition according to a preferred embodiment
of the present invention labelled FBE P115

| Constituent | wt % |
|---|---|
| DI Water | 86.06 |
| Ethanol | 3.18 |
| Lutensol ® XL-90 | 2.83 |
| Novel ® 23E7 | 5.66 |
| Pale Oil 40 | 2.26 |
| Total | 100.00 |

MEA refers to monoethanolamine. According to another preferred embodiment of the present invention, other alkanolamines can be used. These include, but are not limited to, diethanolamine and triethanolamine.

NOVEL® 23E7 and Lutensol® XL-90 surfactants are nonionic surfactants. NOVEL® 23E7 is a biodegradable, nonionic surfactant derived from SAFOL 23 alcohol and ethoxylated to an average of 7 moles of ethylene oxide. It is essentially 100% active unless diluted with water. It is a slightly hazy liquid that is readily soluble in water. Lutensol® XL-90 ethoxylates of alkyl polyethylene glycol ethers is based on the C10-Guerbet alcohol. The Lutensol® XL BASF C₁₀-Guerbet alcohol used for the experiments can be better described as follows: the chemical formula is C₅H₁₁CH(C₃H₇)CH₂OH with the restriction that for 70-99 weight % of compound C₅H₁₁ means n-C₅H₁₁ and for 1-30 weight % C₅H₁₁ means C₂H₅(CH₃)CH₂ and/or CH₃CH(CH₃)CH₂CH₂. According to another preferred embodiment of the present invention, other nonionic surfactants can be used. These include, but are not limited to, linear and branched alcohol ethoxylates with 6-16 carbons and 3-10 moles of EO.

DDBSA is a very versatile surfactant. It exhibits high detergency and excellent foaming character. It can be used in acidic environments as-is or neutralized by numerous bases to form surfactants with many desired properties. Applications for DDBSA include, but are not limited to, household and industrial cleaning applications including cleaners, laundry, carwash, and hard surface care. DDBSA is readily biodegradable.

Pale Oil 40 is a petroleum distillate, hydrotreated heavy naphthenic (CAS #64742-52-5).

Citral is an acyclic monoterpene aldehyde made of two isoprene units. Citral is a collective term which covers two geometric isomers: Geranial (trans-Citral or Citral A); and Neral (cis-Citral or Citral B). Citral appears as a clear yellow colored liquid with a lemon-like odor and has a lower density than water and is insoluble in water.

Triton™ BG-10 is an alkyl polyglucoside-based nonionic surfactant. It is soluble in water as well as in highly caustic solutions. It produces a moderate to high stable foam and displays good detergency and wetting properties. Triton™ BG-10 is readily biodegradable. According to another preferred embodiment of the present invention, other polyglucoside-based nonionic surfactants can be used. These include, but are not limited to, polyglucoside-based nonionic surfactants with different alkyl chain length (C6-C15).

Ethanol is used as a way of providing examples but not to limit the composition of the microemulsions. According to another preferred embodiment of the present invention, other alcohols can be used in the preparation of the microemulsions. These include, but are not limited to, lower alcohols such as methanol as well as longer and more branched alcohols such as propanol, isopropanol, butanol, etc.

According to a preferred embodiment of the present invention, the cellulose used in the method to make NCC is an unbleached cellulose which has a very low lignin and hemicellulose content (preferably ranging from 0.5 to 15 wt %). Preferably, the cellulose is obtained by the delignification of a lignocellulosic biomass feedstock through the exposure of such to a modified Caro's acid as per the following methods. A preferred method to delignify biomass comprises the steps of:
providing a vessel;
providing biomass comprising lignin, hemicellulose and cellulose fibers into said vessel;
providing a sulfuric acid component;
providing a peroxide component;
exposing said biomass to said sulfuric acid source and peroxide component;
allowing said sulfuric acid source and peroxide component to come into contact with said biomass for a period of time sufficient to a delignification reaction to occur and remove over 90 wt % of said lignin and hemicellulose from said biomass.

According to preferred embodiment of the present invention, the modified Caro's acid (as disclosed in Canadian patent application 3,128,678) comprises: sulfuric acid; a heterocyclic compound; and wherein sulfuric acid and said a heterocyclic compound; are present in a molar ratio of no less than 1:1. Preferably, the sulfuric acid and said heterocyclic compound are present in a molar ratio ranging from 28:1 to 2:1. More preferably, the sulfuric acid and heterocyclic compound are present in a molar ratio ranging from 24:1 to 3:1. Preferably, the sulfuric acid and heterocyclic compound are present in a molar ratio ranging from 20:1 to 4:1. More preferably, the sulfuric acid and heterocyclic compound are present in a molar ratio ranging from 16:1 to 5:1. Preferably, the sulfuric acid and heterocyclic compound are present in a molar ratio ranging from 12:1 to 6:1. Also preferably, said heterocyclic compound has a molecular weight below 300 g/mol. Also preferably, said heterocyclic compound has a molecular weight below 150 g/mol. More preferably, said heterocyclic compound is a secondary amine. According to a preferred embodiment of the present invention, said heterocyclic compound is selected from the group consisting of: imidazole; triazole; and N-methylimidazole.

According to preferred embodiment of the present invention, the modified Caro's acid (as disclosed in Canadian patent application 3,128,677) comprises: sulfuric acid; a modifying agent comprising a compound containing an amine group; and wherein sulfuric acid and said compound containing an amine group; are present in a molar ratio of no less than 1:1. Preferably, the sulfuric acid and said compound containing an amine group are present in a molar ratio ranging from 28:1 to 2:1. More preferably, the sulfuric acid and compound containing an amine group are present in a molar ratio ranging from 24:1 to 3:1. Preferably, the sulfuric acid and compound containing an amine group are present in a molar ratio ranging from 20:1 to 4:1. More preferably, the sulfuric acid and compound containing an amine group are present in a molar ratio ranging from 16:1 to 5:1. Preferably, the sulfuric acid and compound containing an amine group are present in a molar ratio ranging from 12:1 to 6:1. According to a preferred embodiment of the present invention, the modifying agent is selected in the group consisting of: TEOA; MEOA; pyrrolidine; DEOA; ethylenediamine; diethylamine; triethylamine; morpholine; MEA-triazine; and combinations thereof. According to a more preferred embodiment of the present invention, the modifying agent is TEOA; MEOA; pyrrolidine; DEOA; ethylenediamine; triethylamine.

According to preferred embodiment of the present invention, the modified Caro's acid (as disclosed in Canadian patent application 3,128,676) comprises: sulfuric acid; a modifying agent comprising an alkanesulfonic acid; and wherein sulfuric acid and said alkanesulfonic acid are present in a molar ratio of no less than 1:1. Preferably, said alkanesulfonic acid is selected from the group consisting of: alkanesulfonic acids where the alkyl groups range from CI-C6 and are linear or branched; and combinations thereof. Preferably, said alkanesulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkanesulfonic acid is methanesulfonic acid. Also preferably, said alkanesulfonic acid has a molecular weight below 300 g/mol. Also preferably, said alkanesulfonic acid has a molecular weight below 150 g/mol. Preferably, the sulfuric acid and said alkanesulfonic acid and are present in a molar ratio ranging from 28:1 to 2:1. More preferably, the sulfuric acid and alkanesulfonic acid are present in a molar ratio ranging from 24:1 to 3:1. Preferably, the sulfuric acid and alkanesulfonic acid are present in a molar ratio ranging from 20:1 to 4:1. More preferably, the sulfuric acid and alkanesulfonic acid are present in a molar ratio ranging from 16:1 to 5:1. According to a preferred embodiment of the present invention, the sulfuric acid and alkanesulfonic acid are present in a molar ratio ranging from 12:1 to 6:1.

According to preferred embodiment of the present invention, the modified Caro's acid (as disclosed in Canadian patent application 3,128,675) comprises: sulfuric acid; a substituted aromatic compound; and wherein sulfuric acid and said substituted aromatic compound; are present in a molar ratio of no less than 1:1. Preferably, the substituted aromatic compound comprises at least two substituents. More preferably, at least one substituent is an amine group and at least one of the other substituent is a sulfonic acid moiety. According to a preferred embodiment, the substituted aromatic compound comprises three or more substituent. According to a preferred embodiment of the present invention, the substituted aromatic compound comprises at least a sulfonic acid moiety. According to another preferred embodiment of the present invention, the substituted aromatic compound comprises an aromatic compound having a sulfonamide substituent, where the compound can be selected from the group consisting of: benzenesulfonamides; toluenesulfonamides; substituted benzenesulfonamides; and substituted toluenesulfonamides. Preferably, the sulfuric acid and said substituted aromatic compound and are present in a molar ratio ranging from 28:1 to 2:1. More preferably, the sulfuric acid and substituted aromatic compound are present in a molar ratio ranging from 24:1 to 3:1. Preferably, the sulfuric acid and substituted aromatic compound are present in a molar ratio ranging from 20:1 to 4:1. More preferably, the sulfuric acid and substituted aromatic compound are present in a molar ratio ranging from 16:1 to 5:1. Preferably, the sulfuric acid and substituted aromatic compound are present in a molar ratio ranging from 12:1 to 6:1.

According to preferred embodiment of the present invention, the modified Caro's acid (as disclosed in Canadian patent application 3,128,674) comprises: sulfuric acid; a modifying agent comprising an arylsulfonic acid; and optionally, a compound containing an amine group; wherein sulfuric acid and said a arylsulfonic acid; are present in a molar ratio of no less than 1:1. Preferably, the compound containing an amine group is selected from the group consisting of: imidazole; N-methylimidazole; triazole; monoethanolamine (MEOA); diethanolamine (DEOA); triethanolamine (TEOA); pyrrolidine and combinations thereof. According to a preferred embodiment of the present invention, sulfuric acid and the peroxide are present in a molar ratio of approximately 1:1. Preferably, the sulfuric acid and said arylsulfonic acid and are present in a molar ratio ranging from 28:1 to 2:1. More preferably, the sulfuric acid and arylsulfonic acid are present in a molar ratio ranging from 24:1 to 3:1. Preferably, the sulfuric acid and arylsulfonic acid are present in a molar ratio ranging from 20:1 to 4:1. More preferably, the sulfuric acid and arylsulfonic acid are present in a molar ratio ranging from 16:1 to 5:1. According to a preferred embodiment of the present invention, the sulfuric acid and arylsulfonic acid are present in a molar ratio ranging from 12:1 to 6:1. Also preferably, said arylsulfonic acid has a molecular weight below 300 g/mol. Also preferably, said arylsulfonic acid has a molecular weight below 150 g/mol. Even more preferably, said arylsulfonic acid is selected from the group consisting of: orthanilic acid; methanolic acid; sulfanilic acid; toluenesulfonic acid; benzenesulfonic acid; and combinations thereof.

According to preferred embodiment of the present invention, the modified Caro's acid (as disclosed in Canadian patent application 3,128,673) comprises: sulfuric acid; a heterocyclic compound; an alkanesulfonic acid; and wherein sulfuric acid and said a heterocyclic compound; are present in a molar ratio of no less than 1:1. Preferably, said aqueous acidic composition comprising: sulfuric acid; a heterocyclic compound; an arylsulfonic acid; and wherein sulfuric acid and said a heterocyclic compound; are present in a molar ratio of no less than 1:1. Preferably, the arylsulfonic acid is toluenesulfonic acid. Preferably, the sulfuric acid, the heterocyclic compound and the alkanesulfonic acid are present in a molar ratio ranging from 28:1:1 to 2:1:1. More preferably, the sulfuric acid the heterocyclic compound and the alkanesulfonic acid are present in a molar ratio ranging from 24:1:1 to 3:1:1. Preferably, the sulfuric acid, the heterocyclic compound and the alkanesulfonic acid are present in a molar ratio ranging from 20:1:1 to 4:1:1. More preferably, the sulfuric acid, the heterocyclic compound and the alkanesulfonic acid are present in a molar ratio ranging from 16:1:1 to 5:1:1. According to a preferred embodiment of the present invention, the sulfuric acid and heterocyclic compound are present in a molar ratio ranging from 12:1:1 to 6:1:1. Also preferably, said heterocyclic compound has a molecular weight below 300 g/mol. Also preferably, said heterocyclic compound has a molecular weight below 150 g/mol. Even more preferably, said heterocyclic compound is selected from the group consisting of: imidazole; triazole; n-methylimidazole; and combinations thereof. Preferably, the alkanesulfonic acid is selected from the group consisting of: alkylsulfonic acids where the alkyl groups range from C1-C6 and are linear or branched; and combinations thereof. Preferably, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkylsulfonic acid is methanesulfonic acid.

According to preferred embodiment of the present invention, the modified Caro's acid (as disclosed in Canadian patent application 3,128,672) comprises: sulfuric acid; a carbonyl-containing nitrogenous base compound; and wherein sulfuric acid and said a carbonyl-containing nitrogenous base compound; are present in a molar ratio of no less than 1:1. According to a preferred embodiment of the present invention, the carbonyl-containing nitrogenous base compound is selected from the group consisting of: caffeine; lysine; creatine; glutamine; creatinine; 4-aminobenzoic acid; glycine; NMP (N-methyl-2-pyrrolidinone); histidine; DMA (N,N-dimethylacetamide); arginine; 2,3-pyridinedicarboxylic acid; hydantoin; and combinations thereof. Preferably, the sulfuric acid and said carbonyl-containing nitrogenous base compound and are present in a molar ratio ranging from 28:1 to 2:1. More preferably, the sulfuric acid and carbonyl-containing nitrogenous base compound are present in a molar ratio ranging from 24:1 to 3:1. Preferably, the sulfuric acid and carbonyl-containing nitrogenous base compound are present in a molar ratio ranging from 20:1 to 4:1. More preferably, the sulfuric acid and carbonyl-containing nitrogenous base compound are present in a molar ratio ranging from 16:1 to 5:1. According to a preferred embodiment of the present invention, the sulfuric acid and carbonyl-containing nitrogenous base compound are present in a molar ratio ranging from 12:1 to 6:1.

According to a preferred embodiment of the present invention, exposing said biomass to said modified Caro's acid composition will allow the delignification reaction to occur and remove over 90 wt % of said lignin and hemicellulose from said biomass.

Preferably, the delignification reaction is carried out at a temperature below 55° C. by a method selected from the group consisting of:
adding water into said vessel;
adding biomass into said vessel; and
using a heat exchanger.

Preferably, said sulfuric acid, said compound comprising an amine moiety and a sulfonic acid moiety and said peroxide are present in a molar ratio of no less than 1:1:1. Also preferably, said sulfuric acid, said compound comprising an amine moiety and a sulfonic acid moiety and said peroxide are present in a molar ratio of no more than 15:1:1.

According to a preferred embodiment of the present invention, said sulfuric acid and said compound comprising an amine moiety and a sulfonic acid moiety are present in a molar ratio of no less than 3:1.

According to a preferred embodiment of the present invention, said compound comprising an amine moiety and a sulfonic acid moiety is selected from the group consisting of: taurine; taurine derivatives; and taurine-related compounds.

According to a preferred embodiment of the present invention, said taurine derivative or taurine-related compound is selected from the group consisting of: taurolidine; taurocholic acid; tauroselcholic acid; tauromustine; 5-taurinomethyluridine and 5-taurinomethyl-2-thiouridine; homotaurine (tramiprosate); acamprosate; and taurates; as well as aminoalkylsulfonic acids where the alkyl is selected from the group consisting of C₁-C₅ linear alkyl and C₁-C₅ branched alkyl. Preferably, said linear alkylaminosulfonic acid is selected form the group consisting of: methyl; ethyl (taurine); propyl; and butyl.

Preferably, said branched aminoalkylsulfonic acid is selected from the group consisting of: isopropyl; isobutyl; and isopentyl.

According to a preferred embodiment of the present invention, said compound comprising an amine moiety and a sulfonic acid moiety is taurine.

According to a preferred embodiment of the present invention, said sulfuric acid and compound comprising an amine moiety and a sulfonic acid moiety are present in a molar ratio of no less than 3:1.

According to a preferred embodiment of the present invention, said compound comprising an amine moiety is an alkanolamine is selected from the group consisting of: monoethanolamine; diethanolamine; triethanolamine; and combinations thereof.

According to a preferred embodiment of the present invention, said compound comprising a sulfonic acid moiety is selected from the group consisting of: alkylsulfonic acids and combinations thereof.

According to a preferred embodiment of the present invention, said alkylsulfonic acid is selected from the group consisting of: alkylsulfonic acids where the alkyl groups range from C₁-C₆ and are linear or branched; and combinations thereof.

According to a preferred embodiment of the present invention, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof.

According to a preferred embodiment of the present invention, said alkylsulfonic acid; and said peroxide are present in a molar ratio of no less than 1:1.

According to a preferred embodiment of the present invention, said compound comprising a sulfonic acid moiety is methanesulfonic acid.

According to a preferred embodiment of the present invention, in Composition C, said sulfuric acid and said a compound comprising an amine moiety and said compound comprising a sulfonic acid moiety are present in a molar ratio of no less than 1:1:1.

According to a preferred embodiment of the present invention, in Composition C, said sulfuric acid, said compound comprising an amine moiety and said compound comprising a sulfonic acid moiety are present in a molar ratio ranging from 28:1:1 to 2:1:1.

Preferably, the sulfuric acid and the peroxide are present in a molar ratio ranging from 7:1 to 1:7.5. More preferably, the sulfuric acid and the peroxide are present in a molar ratio ranging from 3:1 to 1:3. Even more preferably, the sulfuric acid and the peroxide are present in a molar ratio ranging from 2:1 to 1:1.

According to a preferred embodiment of the present invention, the delignification reaction carried out results in a hemicellulose content of less than 15 wt. % of the resulting cellulose. Preferably, the delignification reaction carried out results in a hemicellulose content of less than 10 wt. % of the resulting cellulose. More preferably, the delignification reaction carried out results in a hemicellulose content of less than 5 wt. % of the resulting cellulose.

According to a preferred embodiment of the present invention, the microemulsion is employed as a way to swell the cellulosic fibers resulting from a delignification such as a delignification using modified Caro's acid, to make them more susceptible to the posterior hydrolysis. It is also believed that the microemulsion can possibly intercalate between the cellulosic fibers and helps loosening the fiber structure; thus, exposing more fibers to the subsequent hydrolysis.

### Experimental Method

According to a preferred embodiment of the present invention, the process consists of two steps (1) soaking of the cellulose, (2) catalytic decomposition of H₂O₂ with FeSO₄ or CuSO₄.

### 1) Soaking/Swelling

According to a preferred embodiment of the present invention, this step comprises the soaking of 4 g bulk of NDC in 250 mL DI water for either 1 h or 24 h. In some cases, 1% v/v microemulsion was added to the DI water before soaking the NDC to swell it.

3) Catalytic Decomposition of H₂O₂ with FeSO₄

According to a preferred embodiment of the present invention, this step comprises the following:
1. 50 mL of pretreated cellulose after step (1) or (2) is added to a 100 mL container with a stir bar.
2. 50 mL of 29% H₂O₂ is added to the container
3. 0.5 mL of 10% HCl is added to the container
4. FeSO₄·7H₂O (2.5 g/100 mL) is added to the container
5. The container content is then mixed at 150 rpm at 60° C. for 3 or 6 hours.
6. After the reaction time is complete, the reaction is quenched by either cooling the sample in the fridge or diluting the container contents with cold water to 250 mL total.
7. The precipitate was then washed several times using DI water with filtration or centrifuge.
8. Finally, the solid content was dried in the oven at 55° C. for 48 h to measure the total yield.
9. Dry solid was then dispersed in 50 mL DI water using ultrasonication for 10 minutes

According to another preferred embodiment of the present invention, the process consists of two steps (1) soaking of the cellulose, and (2) catalytic decomposition of H₂O₂ with FeSO₄ CuSO₄ or a combination thereof.

### Experiment #1

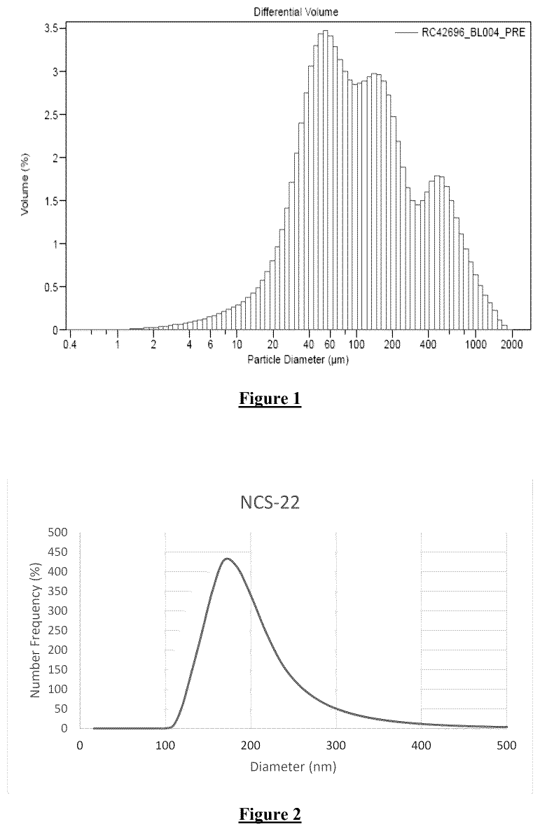

In this experiment, the source of cellulose used was generated by delignification of softwood (NDCSW) using a modified Caro's acid. This generated a “never dried cellulose” which is substantially free of lignin (Kappa number less than 5). The cellulose was not dried prior to being processed into nanocrystalline cellulose. The source of cellulose contained between 20-30% wt. solids and between 5-15% wt. hemicellulose content. The particle size of the starting cellulose was measured to have a D₁₀ of 27.81 μm, a D₅₀ of 99.35 μm and a D₉₀ of 531.0 μm (see FIG. 1).

For this particular experiment, 4 g bulk of NDCSW was added into 250 mL of DI Water. 2.5 g of OSD-P215 was added to the solution. The suspension was stirred for 24 hrs at ambient temperature. The sample was the left to precipitate. The supernatant was decanted and the precipitate was rinsed thoroughly with DI Water then dried in the oven at 45° C. The summary of the experimental parameters and results is listed in Table 6 below, where the reactions were left for 3 hours. Yields were estimated by taking an aliquot of the stable dispersion and drying it in the oven at 105° C.

TABLE 6
Summary of the experimental parameters and results for Experiment #3

| | | | | 29% | | 10% | | Observations |
|---|---|---|---|---|---|---|---|---|
| Sample | MCC | | | H₂O₂ | FeSO₄•7H₂O | HCl | Yield | on final |
| ID | Source | Agent | Sonication | (mL) | (mL) | (mL) | (wt %) | dispersion |
| NCS-22 | NDCSW | N/A | No | 50 | 0.1 | 0.5 | 68 | Top hazy |
| | | | | | | | | liquid and |
| | | | | | | | | stable but |
| | | | | | | | | most cellulose |
| | | | | | | | | precipitated |
| NCS-31 | NDCSW | OSD | No | 50 | 0.1 | 0.5 | 83 | Stable |
| | | P215 | | | | | | dispersion |
| | | | | | | | | with few |
| | | | | | | | | precipitate |

From Table 6, it can be observed that the presence of microemulsion (NCS-31) not only increased the yield after catalytic decomposition but also produced a less turbid solution after sonication with a much lower precipitate compared to the sample without microemulsion (NCS-22). It is known to those skilled in the art that nanocrystalline cellulose will form a stable dispersion in water when sonicated. Therefore, a hazy liquid is determined visually as a good indication of NCC production. FIG. 2 shows the particle size distribution for NCS-22. This highlights the important effect of the microemulsion in generating high yields of NCC.

### Experiment #2

In this experiment, the source of cellulose used was generated by delignification of hardwood (NDCHW) using a modified Caro's acid. This generated a “never dried cellulose” which is substantially free of lignin (Kappa number less than 5). The cellulose was not dried prior to being processed into nanocrystalline cellulose. The source of cellulose contained between 20-30% wt. solids and between 5-10% hemicellulose content.

A 100 g of 8 wt % NaOH soaking solution was prepared. In some cases, 2 g of Nano-X11-3 was added to the soaking solution. Then, 1.5 g solid cellulose was added to the soaking solution and stirred for 2 hours at ambient temperature. Then, cellulose was filtered out and washed thoroughly using DI water. Finally, the cellulose was dried in the oven at 45° C. for 2 days. The summary of the experimental parameters is listed in Table 7 below.

TABLE 7
Summary of the Experimental parameters for the experiment using
Microemulsion Diluted in 8 wt % NaOH without sonication

| | | | Soaking | Soaking |
|---|---|---|---|---|
| Sample | MCC | | Temperature | Time |
| ID | Source | Soaking Agent | (° C.) | (hrs) |
| S#1 | NDCHW | 100 g of 8 wt % NaOH | 20 | 2 |
| S#2 | NDCHW | 100 g of 8 wt % NaOH + | 20 | 2 |
| | | 2 g of Nano-X11-3 | | |

Catalytic Decomposition of H₂O₂ with FeSO₄
1. The synthesis solution was prepared as in the table below using dry pretreated cellulose
2. The solution was heated to 60° C. while stirring for 5 hours
3. After the synthesis, the samples were cooled down using cold water and then allowed to gravity separate before decanting the free water and filtering the precipitate to clean the NCC
4. Finally, the precipitate was dried in the oven for 2 days at 45° C. to obtain the dry NCC.
5. The dry NCC was then added to 50 mL of DI Water and the pH was adjusted (to pH 8-9) using 50 μL of 10 wt % NaOH. Those samples were then sonicated for 15 minutes to disperse the NCC

TABLE 8
Composition and results of samples for Catalytic Decomposition of H₂O₂ with
FeSO₄ for Hardwood where the cellulose was exposed for 5 hours at 60° C.

| | | | | 21.8% | | 10 wt % | | |
|---|---|---|---|---|---|---|---|---|
| Sample | Cellulose | Cellulose | DIW | H₂O₂ | FeSO₄•7H₂O | HCl | Yield | Dispersion of |
| ID | Source | (g) | (mL) | (mL) | (mL) | (mL) | (wt %) | dry NCC |
| NCS-33 | S#1 | 0.11 | 33.5 | 66.5 | 0.1 | 0.5 | 35 | Did not disperse; |
| | | | | | | | | very cloudy and |
| | | | | | | | | separation |
| NCS-34 | S#2 | 0.11 | 33.5 | 66.5 | 0.1 | 0.5 | 31 | Dispersed but |
| | | | | | | | | then separated |
| | | | | | | | | overtime due to |
| | | | | | | | | the low zeta |
| | | | | | | | | potential |

Photographs of samples NCS-33 and NCS-34 were taken and recorded. They establish that, in the absence of microemulsion in the pretreatment step (NCS-33), NCC could not be made as the produced cellulose did not disperse in water upon sonication. In the presence of a microemulsion in the pretreatment step (NCS-34), NCC was achieved as evidenced by a dispersion. Moreover, the NCC was fully dispersed in water after sonication. From this set of experiments, it can be concluded that swelling cellulose in 8 wt % NaOH in the presence of a microemulsion according to a preferred embodiment of the present invention labelled Nano-X11-3 did, in fact, generate, NCC. Based on these observations, it is likely that the yield calculation was inaccurate for NCS-33 and considered MCC instead of NCC. It is known to those skilled in the art that laboratory scale experimentation may have larger errors due to the small volumes handled.

### Experiment #3

The cellulose used in this experiment was obtained from the delignification of hardwood chips using a modified Caro's acid. The cellulose used was not dried after delignification and contained between 20-30% wt. solids. The cellulose was not dried prior to being processed into nanocrystalline cellulose. The source of cellulose had a Kappa number of less than 1 (lignin content <0.13% wt.) and less than 5% wt. hemicellulose content.

In this experiment, 3.2 g of the wet cellulose were added to 200 mL of solution. Said solution was water in the control experiments or water containing an amount of the microemulsion OSD P215 (see Table 9). The cellulose was left in the solutions stirring at room temperature (20-25° C.) for the duration of time outlined in Table 9. After said time, the swollen cellulose was removed from the solution via filtration. amount equivalent to 0.5 g dry of each cellulose sample was then placed in a beaker. 50 mL of 30% H₂O₂ were added to the beaker alongside 0.5 mL of 10% HCl and 0.1 mL of a solution of iron (II) sulfate heptahydrate. The beakers were then placed at 60° C. stirring for 6 hours. After the reaction, the mixtures were centrifuged and washed several times until pH was neutral (pH 6-7). For characterization, the NCC was reslurried in water and sonicated for dispersion at 50 W amplitude. Yields were obtained by taking an aliquot of the stable dispersion after a few days and drying it in the oven at 105° C. Due to the small amounts utilized and the potential errors associated with the measurements, no decimal places are reported. The amount obtained was then extrapolated to the total amount of sample and the starting mass of cellulose.

TABLE 9
Summary of the experimental parameters
and results for Experiment #3

| | Time of | | Yield increase |
|---|---|---|---|
| Sample | soaking | Microemulsion | with respect to |
| ID | (h) | loading (% wt.) | control (wt %) |
| C1 | 1 | 0 | — |
| C2 | 24 | 0 | — |
| ME1 | 1 | 1 | 17 |
| ME2 | 24 | 1 | 17 |
| ME3 | 1 | 5 | 21 |
| ME4 | 24 | 5 | 21 |

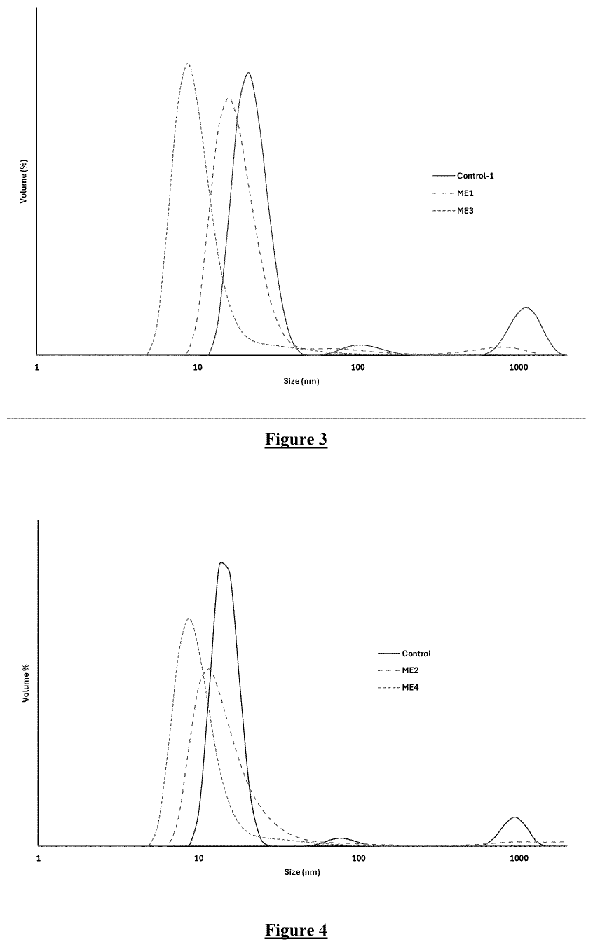

From Table 9, it is observed that a higher yield is obtained when microemulsions are used instead of just water for the soaking step. No significant yield increases are obtained when the soaking step is longer than 1 hour, while slight increases are observed the % wt. loading of the microemulsion in the water solution during the soaking step. This suggests that the microemulsion is allowing the cellulose fibers to become swollen and to become more susceptible to the subsequent attack of the radical decomposition of hydrogen peroxide. FIG. 3 and FIG. 4 show the particle size analysis distribution of the samples outlined in Table 9. From these figures, it is shown that the controls had overall a larger particle size than either of the microemulsion-swollen samples. In addition, there were some larger particles, evidenced by the smaller peaks around 100 and 1000 nm in both FIGS. 3 and 4. As the microemulsion concentration in the solution increased from 1% wt to 5% wt (ME1 to ME3 and ME2 to ME4), a slightly smaller particle size is obtained. This finding is important as it shows how particle size can be fine-tuned within a certain range by using different concentrations of microemulsions in the soaking step. A comparison between FIG. 3 and FIG. 4 shows minimal differences in the particle size between the samples swollen for 24 hours vs those soaked for 1 hour, which indicates longer soaking times are not favouring any further conversion to NCC or altering its particle size. This is beneficial in larger scale facilities where manufacturing time is typically accompanied by significant costs. Decreasing the time from 24 hours to 1 hour (and less) of soaking/swelling of cellulose signifies considerable savings when scaling up this process.

This demonstrates that generating NCC with no sonication is possible and would present a substantial advantage over processes requiring such a step. This is because implementing a sonication step in large scale commercial facilities requires a significant amount of capital investment, as well as large amounts of energy input, which make processes that rely on it less economically profitable and challenging to implement at industrial scale. In addition, sonication in large scale introduces some health and safety issues for operators as high power, energy and temperatures might be reached through sonication.

Furthermore, this process allows for the manufacture of nanocrystalline cellulose from pulp where the cellulose ranges from 100 to 1000 μm. Many other processes currently used to manufacture NCC rely on microcrystalline cellulose (typical particle size between 30-200 μm) as the starting point for their nanocrystalline cellulose manufacturing.

According to a preferred embodiment of the present invention, the process allows for the production of NCC from pulp of a wide distribution of particle size, which significantly lowers production costs as well as raw material costs as the production of microcrystalline cellulose is typically associated with the use of harsh chemicals, high temperatures, and very astringent quality controls. According to a preferred embodiment of the present invention, the process also allows for the production of nanocrystalline cellulose at lower temperatures (<60° C.), which decreases the carbon intensity and energy inputs required in comparison to other processes where hydrolysis and temperatures above 100° C. are required. Other current processes to make NCC involve the use of microwaves which is an approach which is not easily scaled up because of costs and/or other factors.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. A process to manufacture nanocrystalline cellulose from a cellulose having a low hemicellulose content, said process comprising the steps of:
exposing said cellulose to a solution comprising a microemulsion for a first pre-determined period of time, thereby creating a cellulose suspension comprising said microemulsion and a swollen cellulose;
optionally, separating said microemulsion from said swollen cellulose;
exposing said swollen cellulose to a source of peroxide (such as H₂O₂) and a metal salt selected from the group consisting of: FeSO₄; CuSO₄; and combinations thereof, under acidic conditions, for a second pre-determined period causing hydrolysis of the cellulose; and
recovering a resulting nanocrystalline cellulose, wherein the cellulose has a particle size ranging from 100 to 1000 μm.

2. The process according to claim 1, wherein said resulting nanocrystalline cellulose has a crystallinity index of more than 50%, be needle-like and an aspect ratio ranging from 10:1 length to width to 50:1 length to width.

3. The process according to claim 1, wherein said first pre-determined period of time is at least 5 minutes.

4. The process according to claim 1, wherein said first pre-determined period of time ranges from 5 minutes to 24 hours.

5. The process according to claim 1, wherein said first pre-determined period of time ranges from 5 minutes to 1 hour.

6. The process according to claim 1, wherein said first pre-determined period of time ranges from 15 minutes to 1 hour.

7. The process according to claim 1, wherein said first pre-determined period of time ranges from 30 minutes to 1 hour.

8. The process according to claim 1, where the step of exposing the resulting mixture to a source of peroxide and a metal salt occurs at a pH below 7.

9. The process according to claim 1, wherein said microemulsion composition comprises:
water;
a solvent;
a nonionic surfactant; and
a hydrophobic component.

10. The process according to claim 9, where the solvent is selected from the group consisting of: ethanol; methanol; isopropanol; propanol and other short chain alcohols (a linear or branched C₁-C₁₀ alcohol).

11. The process according to claim 9 where the nonionic surfactant is selected from the group consisting of alcohol ethoxylates and/or alkyl polyglucosides.

12. The process according to claim 9, where the hydrophobic component is selected from the group consisting of mineral oil, silicon oil, paraffin oil, and pale oil or a terpene.

13. The process according to claim 9, where an inorganic and/or organic base is added to the microemulsion; where said base is selected from the group consisting of: sodium hydroxide, potassium hydroxide, ammonium hydroxide and alkanolamines such as monoethanolamine (MEA); diethanolamine (DEA); triethanolamine (TEA) and combinations thereof.

14. The process according to claim 9, where the hydrophobic component is present in the composition in an amount ranging from 0.01 wt. % to 20% wt.

15. The process according to claim 9, where the hydrophobic component is present in the composition in an amount ranging from 1 wt. % to 15% wt.

16. The process according to claim 9, where the solvent is present in the composition in an amount ranging from 0.1 wt. % to 20% wt.

17. The process according to claim 1, where the microemulsion composition is added to the water in a concentration ranging from 0.1 to 90% wt.

18. A process to manufacture nanocrystalline cellulose from cellulose having a low lignin and low hemicellulose content wherein the lignin content is less than 1% wt. and the hemicellulose content is less than 15% wt. said process comprising the steps of:
exposing said cellulose to a solution comprising a microemulsion for a first pre-determined period of time, thereby creating a cellulose suspension comprising said microemulsion and a swollen cellulose;
optionally, separating said microemulsion from said swollen cellulose;
exposing said swollen cellulose to a source of peroxide (such as H₂O₂) and a metal salt selected from the group consisting of: FeSO₄; CuSO₄; and combinations thereof, under acidic conditions, for a second pre-determined period causing hydrolysis of the cellulose; and
recovering a resulting nanocrystalline cellulose.

19. A sonication-free method for the preparation of nanocrystalline cellulose from a lignocellulosic biomass feedstock, where said method comprises the following steps:
providing said lignocellulosic biomass feedstock comprising: cellulose; hemicellulose; and lignin;
exposing the biomass to a modified Caro's acid composition having a pH of less than 1, said modified Caro's acid composition selected from the group consisting of: composition A; composition B; composition C; composition D; composition E; composition F; composition G; composition H; composition I; and composition J; wherein said composition A comprises:
sulfuric acid;
a compound comprising an amine moiety and a sulfonic acid moiety; and
a peroxide; and wherein sulfuric acid, said compound comprising an amine moiety and a sulfonic acid moiety and said peroxide are present in a molar ratio of no less than 1:1:1;
wherein said composition B comprises:
sulfuric acid;
a compound comprising an amine moiety;
a compound comprising a sulfonic acid moiety; and
a peroxide; wherein sulfuric acid and said a compound comprising an amine moiety and said compound comprising a sulfonic acid moiety are present in a molar ratio of no less than 1:1:1;
wherein said composition C comprises:
an alkylsulfonic acid; and
a peroxide; wherein said alkylsulfonic acid and said peroxide are present in a molar ratio of no less than 1:1;
wherein said composition D comprises:
sulfuric acid;
a heterocyclic compound; and
a peroxide; and wherein sulfuric acid and said a heterocyclic compound; are present in a molar ratio of no less than 1:1;
wherein said composition E comprises:
sulfuric acid;
a modifying agent comprising a compound containing an amine group; and
a peroxide; and wherein sulfuric acid and said compound containing an amine group; are present in a molar ratio of no less than 1:1;
wherein said composition F comprises:
sulfuric acid;
a modifying agent comprising an alkanesulfonic acid and
a peroxide; and wherein sulfuric acid and said alkanesulfonic acid are present in a molar ratio of no less than 1:1;
wherein said composition G comprises:
sulfuric acid;
a substituted aromatic compound; and
a peroxide; and wherein sulfuric acid and said substituted aromatic compound; are present in a molar ratio of no less than 1:1;
wherein said composition H comprises:
sulfuric acid;
a modifying agent comprising an arylsulfonic acid;
a peroxide; and
optionally, a compound containing an amine group; wherein sulfuric acid and said a arylsulfonic acid; are present in a molar ratio of no less than 1:1;
wherein said composition I comprises:
sulfuric acid;
a heterocyclic compound;
an alkanesulfonic acid and
a peroxide; and wherein sulfuric acid and said a heterocyclic compound; are present in a molar ratio of no less than 1:1;
wherein said composition J comprises:
sulfuric acid;
a carbonyl-containing nitrogenous base compound; and
a peroxide; and wherein sulfuric acid and said a carbonyl-containing nitrogenous base compound; are present in a molar ratio of no less than 1:1;
to create a biomass/acid mixture and allowing exposure to said modified Caro's acid for a period of time sufficient to dissolve enough of the lignin present in said biomass mixture to obtain a kappa number for a remaining solid portion of less than 5 and more preferably, less than 2;
separating the liquid from the remaining solid portion of delignification mixture;
optionally, exposing said remaining solid portion to a caustic composition to dissolve the hemicellulose present therein;
extracting a remaining cellulose;
optionally, adjusting the pH of said remaining cellulose;
exposing said remaining cellulose to a solution comprising a microemulsion for a first pre-determined period of time, thereby creating a cellulose suspension comprising said microemulsion and a swollen cellulose;
optionally, separating said microemulsion from said swollen cellulose;
exposing said swollen cellulose to a source of peroxide (such as H₂O₂) and a metal salt selected from the group consisting of: FeSO₄ or CuSO₄ under acidic conditions, for a second pre-determined period causing hydrolysis of the cellulose; and
recovering a resulting nanocrystalline cellulose.

20. The method according to claim 19, wherein said microemulsion composition comprises:
water;
a solvent;
a nonionic surfactant; and
a hydrophobic component.
